(19) United States
(12) Patent Application Publication
(10) Pub. No.: US 2026/0155324 A1
(43) Pub. Date: Jun. 4, 2026

(54) BASE MODULE FOR HIGH-VOLTAGE SWITCHING DEVICES HAVING VACUUM INTERRUPTERS, AND HIGH-VOLTAGE SWITCHING DEVICE HAVING THE BASE MODULE

(71) Applicant: Siemens Energy Global GmbH & Co. KG, München (DE)

(72) Inventors: Paul Gregor Nikolic, Erlangen (DE); Sylvio Kosse, Coswig (DE); Stefan Giere, Falkensee (DE); Thomas Heinz, Berlin (DE)

(21) Appl. No.: 19/122,371

(22) PCT Filed: Oct. 2, 2023
(86) PCT No.: PCT/EP2023/077227

§ 371 Date: Apr. 18, 2025

(30) Foreign Application Priority Data
Oct. 18, 2022 (DE) 10 2022 210 985.6

(51) Int. Cl. H01H 33/14; H01H 33/66; H01H 33/662; H01H 33/666

(52) U.S. Cl. CPC H01H 33/143; H01H 33/6606; H01H 33/66207; H01H 33/666; H01H 2033/6623; H01H 2033/6665

(57) ABSTRACT

A base module for high-voltage switching devices has at least two vacuum interrupters and at least one coupling element for mechanically coupling the vacuum interrupters to a drive. The at least two vacuum interrupters and the at least one coupling element are combined as a base module in one casing. There is also described a high-voltage switching device having at least one base module, in particular having exactly one base module.

The invention relates to a base module for high-voltage switching devices, having at least two vacuum interrupters and having at least one coupling element for mechanically coupling the vacuum interrupters to a drive. The invention further relates to a high-voltage switching device.

High-voltage switching devices with vacuum interrupters are, e.g., circuit breakers for switching voltages in the high-voltage range, in particular greater than or equal to 52 kV, and/or for switching large currents in the range of up to tens of kiloamperes. Thus, e.g., operating and/or fault currents in an electrical transmission network, e.g., with operating voltages greater than 380 kV, are switchable, i.e., switchable on or off. The vacuum interrupters of a high-voltage switching device are arranged in a dead tank housing, e.g., a metal tank, or in a live tank housing, e.g., an insulator housing, in particular a ribbed ceramic, silicone and/or composite material housing. The housing is, e.g., filled with an insulating gas, e.g., SF₆, CO₂ and/or clean air, i.e., purified, dried air.

A vacuum interrupter comprises two switching contacts or contact pieces movable relative to one another, one fixed contact piece and one mobile contact piece or two mobile contact pieces. At their opposite ends, the contact pieces have contact disks which, in the closed state of the switching device, are in mechanical and electrical contact with one another and, in the opened state, are at a distance from one another, as a result of which a gap is formed in an evacuated space. The gap size is, e.g., in the range from millimeters to centimeters, depending on the maximum voltage to be maintained at the switching device. As a housing, the vacuum interrupter, in particular formed to be cylindrical, has ceramic segments which are connected to one another, in particular soldered, by metallic shield elements, e.g., a copper or steel main shield. At one end, the vacuum interrupter is closed off in a fluid-tight manner by a cover, in particular at the end of the fixed contact piece which projects out of the vacuum interrupter at the end for an electrical contact. At the other end, the vacuum interrupter is closed off in a fluid-tight manner by a bellows, in particular at the end of the contact piece mounted in a mobile manner which projects out of the vacuum interrupter at the end for an electrical contact. If two mobile contact pieces are used, both contact pieces are each mounted in a mobile manner via a bellows. A drive, e.g., a spring-operated drive, is connected to the mobile contact piece or pieces via elements of a kinematic chain, e.g., drive rod and gear parts, for driving or moving the contact pieces during switching of the switching device.

Vacuum interrupters, in particular comprised by high-voltage switching devices, are low-maintenance, durable and are driven easily and reliably, in particular by means of spring-operated drives. For high voltage requirements, e.g., switching devices with a plurality of vacuum interrupters are used whose switching paths are electrically connected in series, as is known, e.g., from DE 10 2013 208 419A1 . Alternatively, e.g., vacuum interrupters having a plurality of switching paths are used, in particular in a vacuum interrupter. For high currents, vacuum interrupters are arrangeable interconnected in parallel.

In the case of a plurality of vacuum interrupters, when the switching paths of the vacuum interrupters are opened, a voltage distribution to the vacuum interrupters that is adapted to the vacuum interrupters is desired, i.e., de-energizing, to avoid overloading individual vacuum interrupters. For example, in the case of a plurality of identically formed vacuum interrupters or switching paths connected in series, a voltage distribution as uniform as possible to the vacuum interrupters or switching paths is desired. In order to achieve a desired voltage distribution to the vacuum interrupters, for example, passive electrical compo such as, e.g., control resistors, control capacitors and/or varistors are connected in parallel to the respective vacuum interrupters.

Vacuum interrupters with elements of the kinematic chain for driving the mobile contact pieces are arranged in the housing of the switching device surrounded by an insulating gas. One or more drives are arranged outside the housing in order to allow easy maintenance. The mobile contact pieces of one or more vacuum interrupters are mechanically connected to the drive or drives via the elements of the kinematic chain. Electrical bushings in the housing of the switching device allow electrical contacting of the vacuum interrupter or vacuum interrupters arranged in the interior of the housing with external contacts for electrical connection to devices to be switched, electrical lines and/or parts of the electrical grid. The switching devices with the components mentioned above, such as, e.g., vacuum interrupters, housings, elements of the kinematic chain and/or drive, are developed for each type of switching device or for each switching device correspondent to the requirements, such as, e.g., maximum switching voltage and/or short-circuit current.

Depending on the electrical requirements, vacuum interrupters are selected or developed, and the drive as well as the kinematic chain are designed. Correspondent to the electro magnetic conditions, housings are designed to ensure sufficient dielectric strength permanently and to prevent break downs, which may destroy a switching device. The insulating gas to be used plays a role in this context. Drives and elements of the kinematic chain are designed correspondent to the vacuum interrupters and the required parameters, such as, e.g., switching times and required forces. This is as sociated with high development costs and low quantities for the individual components, as a result of which high prices for the components arise. A modular structure and a predetermined selection of components has previously been carried out, e.g., for drives which are constructed in different types for different switching devices. Other components such as housings and elements of the kinematic chain, i.e., coupling elements of the vacuum interrupters to the drives, are carried out individually for switching devices.

It is an object of the invention to provide a base module for high-voltage switching devices which saves costs and development efforts, is easily and reliably employable for different switching devices and, in particular, has standardized connection possibilities. Furthermore, it is an object to provide a high-voltage switching device with the base module, with the advantages indicated above.

According to the invention, the object is achieved by a base module for high-voltage switching devices with the features of claim 1 and/or by a high-voltage switching de vice having at least one, in particular having exactly one, base module according to claim 13 described above. Advantageous forms of the base module according to the invention for high-voltage switching devices and/or of the high-voltage switching device according to the invention having at least one, in particular having exactly one, base module described above, are indicated in the dependent claims. Subject matters of the main claim are combinable with features of the dependent claims and features of the dependent claims are combinable with one another.

A base module according to the invention for high-voltage switching devices comprises at least two vacuum interrupters and at least one coupling element for mechanically coupling the vacuum interrupters to a drive. According to the invention, the at least two vacuum interrupters and the at least one coupling element are combined as a base module in one casing.

By combining components, in particular the at least two vacuum interrupters and the at least one coupling element for mechanically coupling the vacuum interrupters to a drive, and by combining them in a casing as a base module, costs are saved. In particular, development costs are saved, and lower costs for components of the high-voltage switching devices may be achieved by means of higher quantities. The electrical and mechanical connectors of the base module and of the high-voltage switching device may be matched to one another in such a way that, equivalent to standardization, different base modules may be installed in a high-voltage switching device and/or a base module may be used in different high-voltage switching devices. Base modules are easily replaceable, e. g., during maintenance, and employable in many high-voltage switching devices or device classes, which is associated with high quantities of the base modules and thus lower costs than in the case of custom production and specialized, respectively adapted designs. The exact requirements for the high-voltage switching device, in particular the switching power, switching voltage and short-circuit currents, are to be realized via the execution in the base module, e.g., by employing and/or combining different vacuum interrupters, in particular without changing the external dimensions of the base module and its connectors for different applications.

The base module may be filled with an insulating material, in particular with a solid insulating material. The insulating material may be and/or comprise a resin, a polymer foam, a plastic, PTFE and/or PCTFE. The insulating material allows electrical insulation of the internal components, such as, e.g., vacuum interrupters in the base module, in order to prevent, e.g., electrical breakdowns when voltage is applied. In particular, materials such as, e.g., resins, polymer foams, plastics, PTFE and/or PCTFE are good electrical insulators. The casing of the base module may likewise be made of or comprise these materials, and/or the filling and the casing form a body, or the insulating material forms the casing.

Control elements, in particular capacitors, resistors and/or varistors, may be arranged in the casing, in particular control elements for each of the at least two vacuum interrupters. Thus, de-energizing of, e.g., the vacuum interrupters is possible, in particular when a plurality of vacuum interrupters are arranged in series, with a compact, cost-effective structure at the same time.

The at least two vacuum interrupters may be electrically interconnected in series, in particular with at least one coupling element arranged spatially between the at least two vacuum interrupters. Thus, high voltages are switchable. A coupling element arranged between the vacuum interrupters and connected to the mobile contact pieces of the at least two vacuum interrupters allows a compact, simple and cost-effective mechanical connection of the mobile contact pieces to a drive, in particular via a single mechanical connector or a mechanical connector of the base module.

The at least two vacuum interrupters may each have at least one fixed and at least one mobile contact piece, wherein the fixed contact pieces may be guided out of the casing as electrical connectors of the base module, and/or the mobile contact pieces, in a chamber which may be arranged outside the vacuum interrupters and inside the casing, may be mechanically connected to the at least one coupling element in a mobile manner. Fixed contact pieces guided out of the casing as electrical connectors of the base module allow simple, low-loss and cost-effective electrical contacting or connection of the base module or of the vacuum interrupters in the base module to other parts of the high-voltage circuit breaker and/or of the base module and/or high-voltage circuit breaker to the electrical grid and/or electrical devices to be switched. Mobile contact pieces mechanically connected to the at least one coupling element in a chamber which may be arranged outside the vacuum interrupters and inside the casing allow compounding or encasing the vacuum interrupters and/or filling the base module with a solid insulating material, wherein the mobile contact pieces and the at least one coupling element remain mounted in a mobile manner in the unfilled chamber, and the filling with insulating material inside the casing and outside the chamber may prevent or inhibit electrical breakdowns.

The vacuum interrupters may be arranged coaxially on a longitudinal axis, and/or the at least one coupling element may be arranged between the at least two vacuum interrupters, in particular comprising a rotary bushing. Thus, a compact, simple and cost-effective structure of the base module is possible, and a simple drive or simple actuation of the mobile contact pieces of the vacuum interrupters during switching is possible via at least one coupling element. In particular, a rotary bushing allows mechanical connection of the mobile contact pieces rotated by 90 degrees relative to the longitudinal axis of the vacuum interrupters, and as a result spaced apart or electrically insulated from the electrical connectors of the base module. Thus, a drive may be arrangeable or arranged with a longitudinal axis perpendicular to the longitudinal axis of the vacuum interrupters. As a result, this results in a simple, compact structure, with a drive electrically insulated and spaced apart from the fixed contact pieces of the vacuum interrupters or the electrical connectors of the base module.

The vacuum interrupters may be arranged with longitudinal axes at an angle of not equal to 180 to one another or may be arranged in parallel to one another, in particular for asynchronous opening and closing of the vacuum interrupters with, in particular, a drive. Depending on the housing of a high-voltage switching device, a parallel arrangement or an arrangement of the vacuum interrupters offset by 180 degrees may result in a compact structure. Material and cost savings are associated with a compact structure. In particular in the case of asynchronously driven vacuum interrupters, an arrangement of the vacuum interrupters with longitudinal axes at an angle of not equal to 180 relative to one another may be advantageous in order to be able to save, e.g., gear elements by means of the arrangement. Further, arrangements of the vacuum interrupters with longitudinal axes at an angle of not equal to 180 relative to one another may, e.g., allow an arrangement of electrical connectors which is safe for maintenance personnel, in particular well insulated from the foundation of the high-voltage switching device. An arrangement of the vacuum interrupters with longitudinal axes at an angle of not equal to 180 allows asynchronous switching, e.g., at a time offset. In particular in the case of different vacuum interrupters, e.g., a predominantly voltage-switching and a predominantly current-switching vacuum interrupter, switching at a time offset or delayed switching between the vacuum interrupters may be advantageous.

The base module may comprise exactly two vacuum interrupters. The advantages described above, in particular with respect to a compact structure with standardized connectors, in particular on opposite sides of the base module, is realized well with exactly two vacuum interrupters. The vacuum interrupters may be completely enclosed by the casing, in particular with the exception of the outwardly guided fixed contact pieces. Alternatively, the vacuum interrupters may be only partially enclosed by the casing, in particular in the region of the mobile contact pieces. The first variant allows good electrical insulation of the connectors of the base module or, in particular, of the fixed contact pieces with respect to one another, whereby electrical breakdowns may be reduced or avoided, in particular in the switched-off state, with voltage applied. Electrical breakdowns may lead to damage and even to the destruction of the base modules and/or vacuum interrupters. The second variant, i.e., the vacuum interrupters are only partially enclosed by the casing, may lead to a saving in material and thus to a saving in cost and to a compact structure. In particular in live tank circuit breakers, with an insulator as the housing, partial encasing of the vacuum interrupters by the casing may be sufficient to allow sufficient dielectric strength without electrical breakdowns.

The at least two vacuum interrupters may comprise different vacuum interrupters, in particular at least one vacuum interrupter for current interruption and at least one vacuum interrupter for voltage insulation, which may be designed differently, in particular in terms of spatial dimensions, in terms of structure, in terms of stroke, and/or in terms of current/voltage carrying capacity. Thus, different tasks and areas of employment of the base modules are realizable in a simple and cost-effective manner, e.g., employment at certain maximum voltage levels and/or short-circuit current intensities. Correspondent to the housing of the high-voltage switching device and/or the dimensions of the base module, the vacuum interrupters may be designed with predetermined current/voltage carrying capabilities.

A high-voltage switching device according to the invention having at least one base module, in particular having exactly one base module, as described above, comprises that the high-voltage switching device is designed to switch voltages in the high-voltage range, in particular in the range of greater than or equal to 52 kV, and/or that the high-voltage switching device is filled with clean air as an insulating gas. Clean air as an insulating gas allows environmentally friendly, CO₂ neutral or climate-friendly insulation of the switching device in the interior. The advantages described above with respect to the base module are applicable, in particular, in switching devices in the high-voltage range, e.g., in the range of the switching voltage of greater than 52 kV.

Each base module of the high-voltage switching device may comprise exactly two outward electrical connectors and exactly one mechanical connector for the drive. Thus, all the necessary properties are realizable with a minimum number of connectors. The high-voltage switching device may comprise bae modules, in particular with standardized, identical external dimensions. This makes it possible to have high quantities of the base modules, which is associated with scaling effects, such as, e.g., low costs per base module.

The advantages of the high-voltage switching device according to the invention having at least one base module, in particular having exactly one base module, as described above, according to claim 13 are analogous to the advantages of the base module according to the invention for high-voltage switching devices according to claim 1 described above, and vice versa.

In the following, exemplary embodiments of the invention are schematically illustrated in the figures and described in more detail below.

In the Figures:

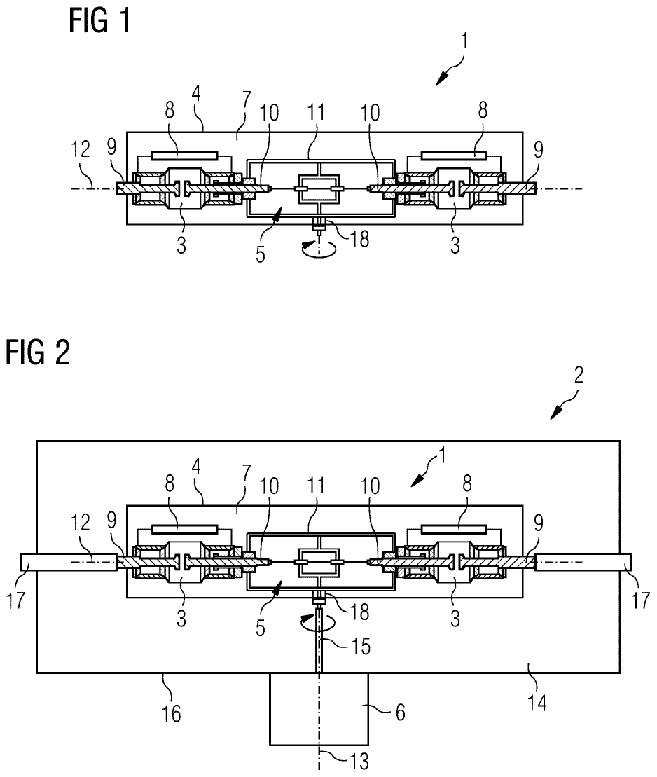

FIG. 1 schematically shows a base module 1 according to the invention for high-voltage switching devices, having at least two vacuum interrupters 3 and one coupling element 5 combined in one casing 4, and

FIG. 2 schematically shows a high-voltage switching device 2 according to the invention having the base module 1 of FIG. 1.

FIG. 1 schematically shows a base module 1 according to the invention for high-voltage switching devices in a lateral sectional view. The base module 1 comprises two vacuum interrupters 3 and one coupling element 5, which are arranged in a casing 4. The casing 4 is or comprises, e.g., a housing made of plastic or metal, in particular sheet steel and/or aluminum. The casing 4 is in particular filled with an insulant 7, e.g., an insulating gas, in particular SF 6, CO₂ and/or clean air, i.e., purified air, and/or is filled with a solid as the insulant 7, e.g., a resin, polymer foam, plastic, PTFE and/or PCTFE. The filling made of the insulant 7 may also form the casing 4 without a housing type external boundary being comprised.

In the exemplary embodiment of FIG. 1, the base module 1 comprises two vacuum interrupters 3. Alternatively, more than two vacuum interrupters 3 may also be comprised. The vacuum interrupters 3 each have a housing which comprises, e.g., a central main shield and a ceramic segment adjoining flush to the right and left. The main shield and the ceramic segments are, e.g., formed to be hollow-cylindrical or tubular, and are each sealed in a fluid-tight manner at the ends of the vacuum interrupter 3. In the interior, the vacuum interrupter 3 is evacuated or there is a vacuum. the ends of the vacuum interrupter 3, contact pieces 9, 10 project into the housing of the vacuum interrupter 3, e. g., a fixed contact piece 9 from one side or base surface of the cylinder and a mobile contact piece 10 from the other side or top surface of the cylinder, i.e., the vacuum interrupter 3.

The main shield is made, e.g., of a metal, in particular copper and/or steel, and comprises, e.g., in its interior vapor-deposition shields which are not shown in the figures for the sake of simplicity. The hollow-cylindrical ceramic segments are manufactured, e.g., of sintered ceramic and are in particular surface-treated. The ceramic segments comprise, e.g., ceramic segment elements which are connected to one another via vapor shields. A connection is established, e.g., during a soldering operation in a furnace at several hundred degrees Celsius, during the manufacture of the vacuum interrupter 3. The vapor shields are made, e.g., of metal, in particular copper and/or steel, and are formed to be annular. In the interior of the vacuum interrupter 3, the vapor shields comprise, e.g., vapor-deposition shields which are not shown in the figures for the sake of simplicity. When pulled outwards, the vapor shields project, e.g., in the form of flat rings, out of the vacuum interrupter 3 or beyond the circumference of the ceramic segment element. The vapor shields divide a respective ceramic segment into ceramic segment elements.

The contact pieces 9, 10 of the vacuum interrupter 3 are made, e.g., of copper and/or steel, and are in particular bolt-shaped, having, e.g., slotted, disk-shaped ends in the interior of the vacuum interrupter 3. The fixed contact piece 9 is connected, e.g., in a fluid-tight manner, to a cover-shaped seal on one end of the vacuum interrupter 3, wherein the seal is manufactured, e.g., from a metal, in particular copper and/or steel. The mobile contact piece 10 is connected, e.g., in a fluid-tight manner, in a mobile manner to a bellows on the other end of the vacuum interrupter 3, wherein the bellows is manufactured, e.g., from a metal, in particular steel, and seals the vacuum interrupter 3 in a fluid-tight manner.

The vacuum interrupter is electrically contactable via the outwardly guided bolts of the fixed contact piece 9 and of the mobile contact piece 10. The mobile contact piece 10 allows electrical switching by movement towards the fixed contact piece 9, i.e., for closing a gap between the disk-shaped contact piece ends of the contact pieces 9 and 10, upon switching on, and by movement away from the fixed contact piece 9, i.e., for creating a gap between the disk-shaped contact piece ends of the contact pieces 9 and 10, upon switching off. Alternatively or additionally, two or more mobile contact pieces may also be used. The gap created between the contact piece ends of the contact pieces 9 and 10 as well as the contact piece ends themselves are arranged in the evacuated interior of the vacuum interrupter 3, as a result of which a gap in the range from millimeters to centimeters is sufficient for switching off, in particular, high voltages. The vacuum interrupter 3 has, e. g., a length in the range of in particular 30 to 100 centimeters, and a circumference in the range of in particular 10 to 100 centimeters.

Control elements 8, e.g., are arranged around the circumference or remote from the housing of the vacuum interrupter 3 and/or connected in parallel to the vacuum interrupter 3, as shown in FIGS. 1 and 2. The control elements 8 are arranged, e.g., in the casing 4. Control elements 8 are in particular capacitors, resistors and/or varistors. Capacitors are in particular ceramic capacitors, e.g., with values of the capacitance of individual capacitors in the range of 10 to 4000 pF. This results in a total capacitance of the arrangement, e.g., in the range of 10 to 4000 pF. Resistors are in particular Ohmic resistors, e.g., with values of individual resistors in the range from a few ohms to several hundred, or several thousand, or several ten thousand ohms, or several hundred thousand ohms. This results in a total resistance in the range from a few ohms to several hundred ohms, several thousand ohms, several ten thousand ohms, or several hundred thousand ohms. Via the control elements 8, the voltages are de-energizeable via the vacuum interrupters, in particular in the case of series connection of a plurality of vacuum interrupters.

In the exemplary embodiment of FIGS. 1 and 2, the two vacuum interrupters 3 of the base module 1 for high-voltage switching devices 2 are electrically interconnected, in particular connected in series, via the coupling element 5. Elements of the coupling element 5 are electrically conductive, e.g., made of a metal, in particular copper and/or steel, and electrically connect the contact pieces 10, which are mobile in the exemplary embodiment, to one another. The mobile contact pieces 10 are mechanically drivable via the coupling element 5, in particular during switching. In particular, a rotary element and/or a rotary gear may be provided, which is comprised by the coupling element 5, is arranged between the two vacuum interrupters 3 and is connected mechanically as well as electrically to the mobile contact pieces 10 in order to drive the mobile contact pieces 10 during switching, in particular in opposite directions.

The rotary element and/or rotary gear is arranged, e.g., in a chamber 11, in particular in a mobile manner, in order to allow movement of the contact pieces 10, in particular in the case of a casing 4 of the base module 1 filled with a solid as the insulant 7. The contact piece ends of the mobile contact pieces 10, which project from the interior of the vacuum interrupters 3, are arranged in the chamber 11 in a mobile manner and are mechanically connected to the rotary element and/or rotary gear in the chamber 11. The casing 4 is fillable or filled with an insulant 7, with the exception of the interior of the vacuum interrupters 3 and the chamber 11, e.g., by potting and/or foaming with a solid. In particular, a drive shaft and/or drive rod 15 for driving the rotary element and/or rotary gear, mechanically connected to the coupling element 5, is guided in a mobile manner, e.g., in a sleeve 18, from the outside of the chamber 11 to the inside of the casing 4. Alternatively, the chamber 11 is arranged, e.g., directly on a lateral surface of the casing 4, in order to allow movement of the mobile elements, e.g., of a drive shaft, of the rotary element and/or rotary gear, and/or of the mobile contact pieces 10 connected to the coupling element 5, in particular when filling the casing 4 with a solid insulant 7. Alternatively or additionally, the region of the coupling element 5, of the drive rod 15 and of the mobile contact pieces 10 as well as their mechanical connections is to be kept free or is kept free from the insulant 7.

FIG. 2 shows the base module 1 according to the invention arranged in a high-voltage switching device 2, in particular a circuit breaker or high-voltage circuit breaker. Via a drive rod 15, in particular a rotary shaft, the mobile contact pieces 10 of the vacuum interrupters 3 are drivable or movable during switching, in particular via the rotary element or elements and/or the rotary gear comprised by the coupling element 5. The drive rod 15 mechanically connects, as a part of a kinematic chain, the mobile contact pieces 10 of the vacuum interrupters 3, in particular via the rotary element or elements and/or the rotary gear comprised by the coupling element 5, to a drive 6. The drive 6 is, e. g., a spring-operated drive and/or comprises a motor, in particular an electric motor.

In the exemplary embodiment of the figures, the vacuum interrupters 3 are arranged on a common axis 12 which corresponds to the longitudinal axes of the vacuum interrupters 3, i.e., coaxially or congruently. Alternatively, the vacuum interrupters 3 may be arranged offset relative to one another with parallel longitudinal axes or with an angle of the axes not equal to 180 degrees relative to one another, e.g., with an angle of 90 degrees, in particular during asynchronous switching of the vacuum interrupters 3. As an alternative to a rotary movement, the drive rod 15 may transmit the driving force by means of a translational movement, in particular in conjunction with at least one gear. The drive rod 15 and the drive 6 lie, e. g., on a common axis, in particular the longitudinal axis of the drive 6. Alternatively, further elements of a kinematic chain may be arranged between the drive 6 and the coupling element 5, which, e. g., allow an arrangement of the drive 6 obliquely or offset relative to the coupling element 5 and/or the drive rod 15. One or more drives 6 drive, e.g., a base module 1 or a plurality of base modules 1 at the same time or at a time offset.

In the figures, an exemplary embodiment with a T-shaped arrangement of the vacuum interrupters 3 and of the drive 6 is shown by way of example, wherein the vacuum interrupters 3 are arranged in the casing 4 on a common axis 12 with axial co longitudinal axes 12 of the vacuum interrupters 3, with the coupling element 5 arranged in the casing 4 between the vacuum interrupters 3. At a 90-degree angle to the axis 12, the drive rod 15 is arranged coaxially with the drive 6 on the common longitudinal axis of the drive 13, resulting in a T-shaped arrangement. The high-voltage switching device 2, which is shown schematically as an exemplary embodiment in a lateral sectional view in FIGS. 2, comprises a housing 16 which is filled, e. g., with an insulating gas 14 in the interior, e.g., with SF₆, CO₂ and/or clean air or purified air. Arranged in the housing 16 of the high-voltage switching device 2 is a base module 1 which is being or is electrically contacted and/or mechanically fastened, e.g., via the fixed contact pieces 9 of the vacuum interrupters 3 which project from the base module 1. For this purpose, e.g., the connectors of the high-voltage switching device 17, which serve for electrical connection, e.g., to the grid, to electrical devices and/or installations to be switched, are guided from the outside into the housing 16, and are electrically and/or mechanically connected to the fixed contact pieces 9 of the vacuum interrupters 3, which serve for contacting the base element 1. The drive 6, which is fastened to the housing 16, is mechanically connected to the base module 1, in particular to the coupling element 5 of the base module 5, e.g., via the drive rod 15, which is guided in the housing 16 from the drive 6 to the base module 1. As a result, the driving force or driving movement of the drive 6 is transmittable to the coupling element 5 via the drive rod or shaft to the mobile contact pieces 10 of the vacuum interrupters 3, in particular during switching of the high-voltage switching device 2 or the base module 1.

The exemplary embodiments described above may be combined with one another and/or may be combined with the prior art. Hence, e. g., instead of a base module 1, two or more base modules 1 may also be provided in the housing 16 of the high-voltage switching device 2. The high-voltage switching device 2 may have more than one housing 16 with a base module 1 or base modules 1, in particular with identically embodied, e.g., standardized, base modules 1. Housings 16 with a base module 1 and/or base modules 1 may be provided, e.g., for each electrical phase to be switched. One or more drives 6 may be provided for this purpose. The vacuum interrupters 3 of one or more base modules 1 may be connected in series and/or in parallel. The housing 16 of the high-voltage switching device 2 is, e.g., a metal tank sealed in a gas-tight manner and/or an insulator housing sealed in a gas-tight manner. Metal tank housings are, e.g., made of steel and/or aluminum, in particular at ground potential in the manner of a dead tank. Insulator housings are made, e.g., of ceramic, silicone and/or composite materials, in particular having a ribbed external surface for extending leakage current paths. The housing 16 is filled, e.g., with clean air, i.e., purified air, as the insulating gas 14, which is climate neutral. Alternatively or additionally, insulating gases 14 such as, e.g., SF₆ and/or CO₂ may be used.

The coupling element 5 is arranged in a chamber 11, in particular in the case of a solid insulant 7 in the casing 4. In the case of gaseous insulants in the casing 4, such as, e. g., SF₆, CO₂ and/or clean air, the chamber 11 may be omitted. The chamber 11, the casing 4 and/or the housing 16 may comprise gases having different pressures.

As shown in the figures, the vacuum interrupters 3 are connected to one another via the mobile contact pieces 10, in particular electrically and mechanically via the coupling element 5. Alternatively, the vacuum interrupters 3 may be electrically connected to one another via the fixed contact pieces 9, e.g., via a cable, and may be mechanically insulated, e.g., electrically, via the coupling element. An electrical and/or mechanical connection is alternatively effected via a mobile 10 and a fixed 9 contact piece. A drive 6, e.g., a motor and/or spring-operated drive, or a plurality of drives 6 may be provided in order to move or drive the mobile contact pieces 10. Elements of the kinematic chain may comprise a drive rod 15, gear and/or shafts. Alternatively, the coupling element 5 may be driven directly by the drive 6.

The use of identical or different base modules 1, which may be produced cost-effectively in large quantities, in particular with identical external dimensions, allows easy re-placement in high-voltage switching devices 1. In a switching device type, different base modules, in particular with the same external dimensions and/or connectors, may be used. Thus, e.g., when using various vacuum interrupters 3 and/or a different number of vacuum interrupters 3 in one or more base modules 1, a simple adaptation of a switch type to different voltages and/or currents to be switched is possible. Alternatively, identical or different base modules 1, in particular with identical external dimensions and/or connectors, may be used in different high-voltage switching devices 2, wherein, e.g., for adapting the voltages and/or currents to be switched, the number of base modules 1 in the switching device type is changed, i.e., the housing 16 is adapted correspondent to the desired switching properties, when using standardized, cost-effective base modules 1 in particular.

### REFERENCE SIGNS LIST

1 Base module
2 High-voltage switching device
3 Vacuum interrupter
4 Casing
5 Coupling element to a drive
6 Drive
7 Insulant
8 Control element
9 Fixed contact piece
10 Mobile contact piece
11 Chamber
12 Longitudinal axis of the vacuum interrupters
13 Longitudinal axis of the drive
14 Insulating gas
15 Drive rod
16 High-voltage switching device housing
17 Connector of the high-voltage switching device
18 Sleeve

1-14. (canceled)

15. A base module for high-voltage switching devices, the base module comprising:
at least two vacuum interrupters and at least one coupling element for mechanically coupling said at least two vacuum interrupters to a drive; and
a casing containing said at least two vacuum interrupters and said at least one coupling element combined to form the base module in said casing.

16. The base module according to claim 15, wherein the base module is filled with an insulating material.

17. The base module according to claim 16, wherein said insulating material is a solid insulating material.

18. The base module according to claim 16, wherein said insulating material is selected from the group consisting of a resin, a polymer foam, a plastic, polytetrafluoroethylene (PTFE) and polychlorotrifluoroethylene (PCTFE).

19. The base module according to claim 15, which further comprises control elements selected from the group consisting of capacitors, resistors, and varistors disposed in said casing.

20. The base module according to claim 15, wherein said at least two vacuum interrupters are electrically interconnected in series and said at least one coupling element is arranged spatially between said at least two vacuum interrupters.

21. The base module according to claim 15, wherein:
each of said at least two vacuum interrupters has at least one fixed contact piece and at least one mobile contact piece;
said fixed contact pieces are guided out of said casing to form electrical connectors of said base module; and
said mobile contact pieces are disposed in a chamber outside said at least two vacuum interrupters and inside said casing, and said mobile contact pieces are mechanically and movably connected to said at least one coupling element.

22. The base module according to claim 15, wherein said at least two vacuum interrupters are arranged coaxially along a longitudinal axis and said at least one coupling element is arranged between said at least two vacuum interrupters.

23. The base module according to claim 22, wherein said at least one coupling element is a rotary bushing.

24. The base module according to claim 22, wherein the drive to be coupled to said at least two vacuum interrupters is to be disposed with a longitudinal axis thereof perpendicular to the longitudinal axis of said vacuum interrupters.

25. The base module according to claim 15, wherein said at least two vacuum interrupters are arranged with longitudinal axes thereof at an angle different from 180° relative to one another or said at least two vacuum interrupters are arranged parallel to one another.

26. The base module according to claim 25, wherein said at least two vacuum interrupters are configured for asynchronous opening and closing thereof by way of the drive.

27. The base module according to claim 15, wherein said at least two vacuum interrupters are exactly two vacuum interrupters.

28. The base module according to claim 15, wherein said vacuum interrupters are completely enclosed by said casing, except for outwardly guided fixed contact pieces thereof.

29. The base module according to claim 15, wherein each of said at least two vacuum interrupters has a fixed contact piece and a mobile contact piece, and said vacuum interrupters are only partially enclosed by said casing in a region of said mobile contact pieces.

30. The base module according to claim 15, wherein said at least two vacuum interrupters comprise mutually different vacuum interrupters, including at least one vacuum interrupter for current interruption and at least one vacuum interrupter for voltage insulation.

31. The base module according to claim 15, wherein said at least two vacuum interrupters comprise mutually different vacuum interrupters having different design specifications selected from the group consisting of spatial dimensions, a structure, a stroke, a current carrying capacity and a voltage carrying capacity.

32. A high-voltage switching device, comprising:
at least one base module according to claim 15;
wherein the high-voltage switching device is configured for switching voltages in a high-voltage range greater than or equal to 52 kV.

33. The high-voltage switching device according to claim 32, wherein said base module is filled with clean air as an insulating gas.

34. The high-voltage switching device according to claim 32, wherein said base module is exactly one base module.

35. The high-voltage switching device according to claim 32, wherein each said at least one base module comprises exactly two outward electrical connectors and exactly one mechanical connector for the drive, and said base modules have standardized, identical external dimensions.
